(19) United States
(12) Patent Application Publication
(10) Pub. No.: US 2022/0117219 A1
(43) Pub. Date: Apr. 21, 2022

(54) SNARE TRAP

(71) Applicant: JIAN-FU LIN, Taichung City (TW)

(72) Inventor: JIAN-FU LIN, Taichung City (TW)

(21) Appl. No.: 17/563,739

(22) Filed: Dec. 28, 2021

Related U.S. Application Data
(63) Continuation-in-part of application No. 16/794,544, filed on Feb. 19, 2020.

(30) Foreign Application Priority Data
Mar. 13, 2019 (TW) 108203001

(51) Int. Cl. A01M 23/34

(52) U.S. Cl. CPC A01M 23/34

(57) ABSTRACT

A snare trap is provided, including a trigger base and a snare assembly. The snare assembly includes a cable having a noose, an abutting mechanism sleeved on the cable, a restricting mechanism disposed on the cable and an elastic member disposed between the abutting mechanism and the restricting mechanism. The noose is releasably disposed around the trigger base, and the elastic member is compressible and restricted by the restricting mechanism. The elastic member includes a plurality of segments connected with one another, and at least one of the plurality of segments includes a plurality of coils each having an outer diametric dimension different from an outer diametric dimension of another one of the plurality of coils. When the noose is disposed around the trigger base and the elastic member is compressed, at least two of the plurality of coils are radially overlapped with each other.

### BACKGROUND OF THE INVENTION

The present invention is a CIP of application Ser. No. 16/794544, filed Feb. 19, 2020, the entire contents of which are hereby incorporated by reference.

### FIELD OF THE INVENTION

### DESCRIPTION OF THE PRIOR ART

A conventional snare trap includes a trigger base, a cable and a spring mechanism. The spring mechanism includes an abutting member, a restricting member, a spring and a sleeving tube. The abutting member and the restricting member are disposed on the cable, and the spring and the sleeving tube are disposed between the abutting member and the restricting member. In operation, the cable forms a noose which keeps its configuration by the trigger base, and then the spring is compressed between the abutting member and the restricting member and restricted by the restricting member to accumulate force. The sleeving tube guides and receives the spring during compression of the spring for easy operation. An end of the cable opposite to the noose is fixed on an object (such as tree, pillar or the like) and the trigger base is disposed on a pit. When an animal is stepped on the trigger base, the trigger base drops into the pit and the noose is detached from the trigger base and sleeved on the animal's foot, and the spring stretches and pushes the abutting member to tighten the noose about the animal's foot.

However, the spring of the conventional snare trap has a long solid length so that the sleeving member with a dimension corresponding to the solid length of the spring is required to receive the whole spring, which increase weight and volume of the snare trap and is inconvenient to carry and set.

The present invention is, therefore, arisen to obviate or at least mitigate the above-mentioned disadvantages.

### SUMMARY OF THE INVENTION

The main object of the present invention is to provide a snare trap which has a light weight and a small volume and is easy to carry and set. To achieve the above and other objects, the snare trap of the present invention includes a trigger base and a snare assembly. The snare assembly includes a cable having a noose, an abutting mechanism sleeved on the cable, a restricting mechanism disposed on the cable and an elastic member disposed between the abutting mechanism and the restricting mechanism. The noose is releasably disposed around the trigger base, and the elastic member is compressible and restricted by the restricting mechanism. The elastic member includes a plurality of segments connected with one another, and at least one of the plurality of segments includes a plurality of coils each having an outer diametric dimension different from an outer diametric dimension of another one of the plurality of coils. The elastic member has a free length when being free of compression. When the noose is disposed around the trigger base and the elastic member is compressed and restricted by the restricting mechanism, at least two of the plurality of coils are radially overlapped with each other, and the elastic member has a solid length which is shorter than 1/3 of the free length.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is an enlargement of the present invention;

FIG. 3 is a stereogram showing assembling of the present invention;

FIG. 4 is a cross sectional view of the present invention when an elastic member is compressing;

FIG. 5 is a cross sectional view of the present invention when the elastic member is totally compressed;

FIG. 6 is a schematic diagram showing comparison between a free length and a solid length of the elastic member of the present invention;

FIG. 7 is a cross sectional view showing setting of the present invention;

FIG. 8 is a schematic diagram showing operation of the present invention.

### DETAILED DESCRIPTION OF THE PREFERRED EMBODIMENTS

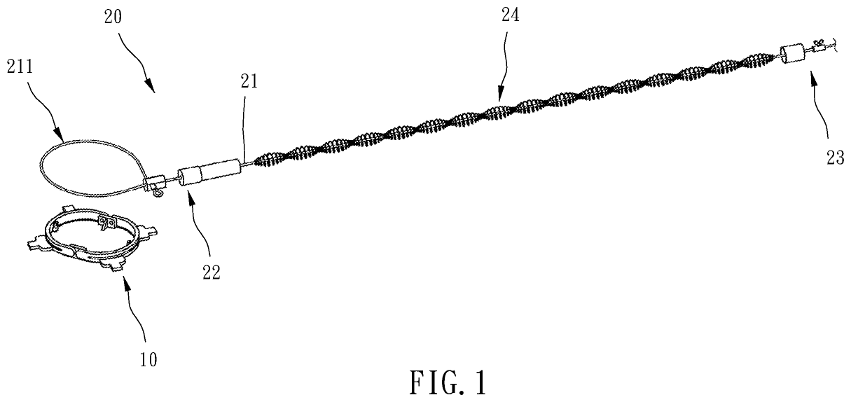

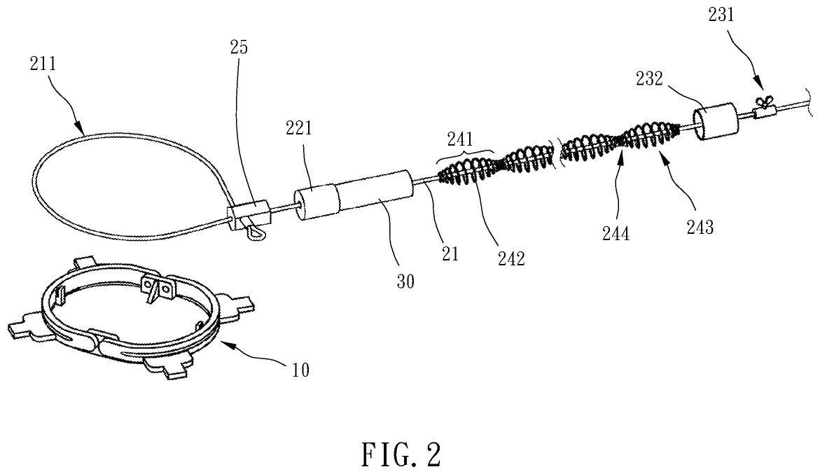

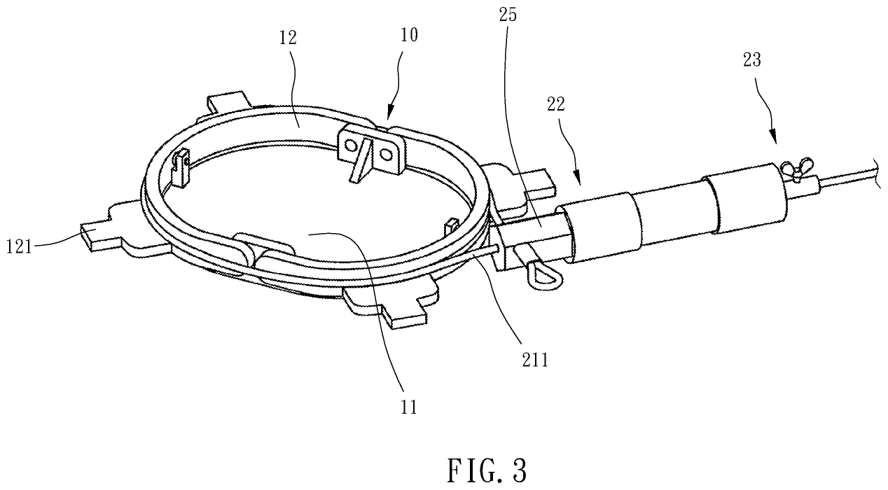

Please refer to FIGS. 1 to 8 for a preferable embodiment of the present invention. A snare trap of the present invention includes a trigger base 10 and a snare assembly 20.

The snare assembly 20 includes a cable 21 having a noose 211, an abutting mechanism 22 sleeved on the cable 21, a restricting mechanism 23 disposed on the cable 21 and an elastic member 24 disposed between the abutting mechanism 22 and the restricting mechanism 23. The noose 211 is releasably disposed around the trigger base 10, and the elastic member 24 is compressible and restricted by the restricting mechanism 23. The elastic member 24 includes a plurality of segments 241 connected with one another, and at least one of the plurality of segments 241 includes a plurality of coils 242 each having an outer diametric dimension different from an outer diametric dimension of another one of the plurality of coils 242. The elastic member 24 has a free length L1 when being free of compression. When the noose 211 is disposed around the trigger base 10 and the elastic member 24 is compressed and restricted by the restricting mechanism 23, at least two of the plurality of coils 242 are radially overlapped with each other, and the elastic member 24 has a solid length L2 which is shorter than ⅓ of the free length L1. Therefore, the snare trap has a light weight and a small volume and is easy to carry and set.

The elastic member 24 includes a plurality of large-diametric portions 243 and a plurality of small-diametric portions 244 which are axially alternatively arranged. When the elastic member 24 is compressed, part of the plurality of small-diametric portions 244 are radially overlapped with the plurality of large-diametric portions 243 so as to greatly decrease a length of the elastic member 24 after compression. A ratio of a maximum outer diameter of one of the plurality of large-diametric portions 243 to a minimum outer diameter of one of the plurality of small-diametric portions 244 is between 2 and 5 so that the elastic member 24 has good structural strength and the plurality of large-diametric portions 243 are large enough to receive the plurality of small-diametric portions 244.

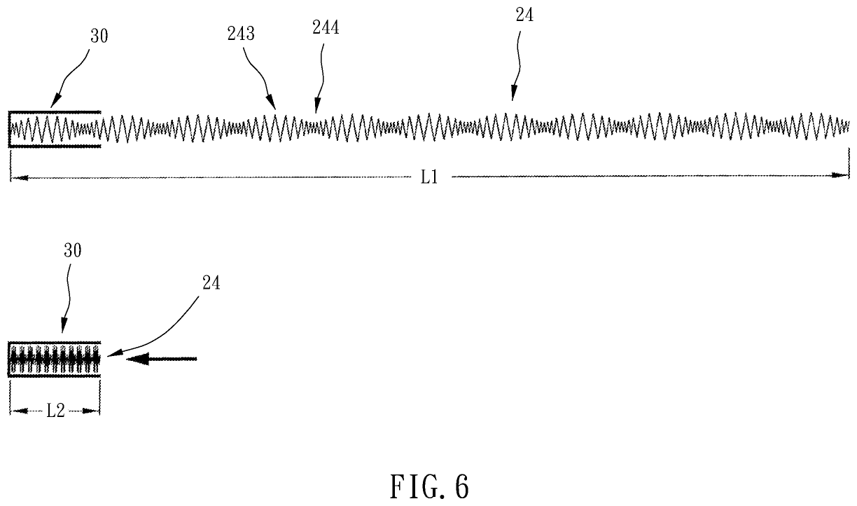

In this embodiment, the elastic member 24 includes at least 5 of said segments 241; the plurality of segments 241 are continuously connected with one another, which provides sufficient elastic force; each of the plurality of segments 241 spirally extends and is tapered from one of the plurality of large-diametric portions 243 toward one of the plurality of small-diametric portions 244, which allows the elastic member 24 to have a small volume and preferable force accumulating effect when the elastic member 24 is compressed. With structures as described above, the elastic member 24 is compressible from the free length L1 to the solid length L2, which greatly decreases the volume of the snare trap, as shown in FIG. 6. Preferably, a ratio of the free length L1 to the solid length L2 is between 8 and 15. For example, the free length L1 may be between 100 cm and 120 cm, and the solid length L2 may be between 8 cm and 12 cm so that the elastic member 24 provides sufficient elastic potential energy to tighten the noose 211. In other embodiments, the plurality of segments may be separately sleeved on the cable and be movable to connected with one another; adjacent two of the plurality of segments may be connected with each other by a connecting segment such as a rod, coils having the same diametrical dimensions or the like.

A diameter of the cable 21 is between 2 mm and 10 mm, and a wire diameter of the elastic member 24 is between 1.5 mm and 3.0 mm so as to provide sufficient structural strength. Preferably, the diameter of the cable 21 is between 4 mm and 8 mm, the wire diameter of the elastic member 24 is between 1.6 mm and 2.6 mm, and a ratio of the diameter of the cable 21 to the wire diameter of the elastic member 24 is between 2.0 and 3.5 so that the elastic member 24 can provide appropriate elastic force to tighten the noose 211 of the cable 21, which prevents the noose 211 from being over-tightened or insufficiently tightened.

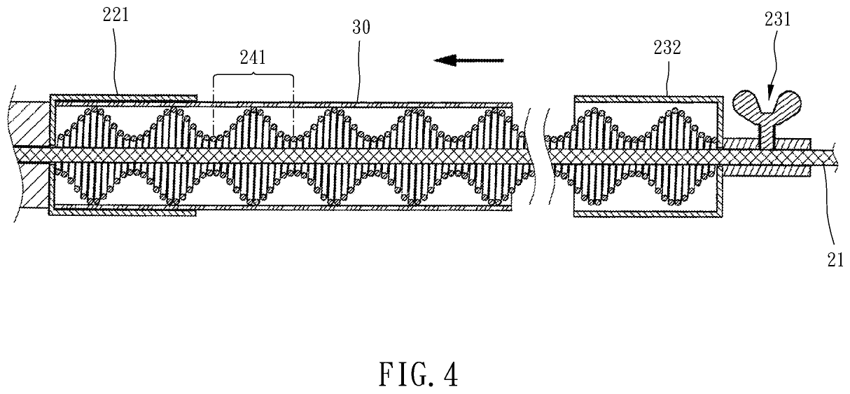

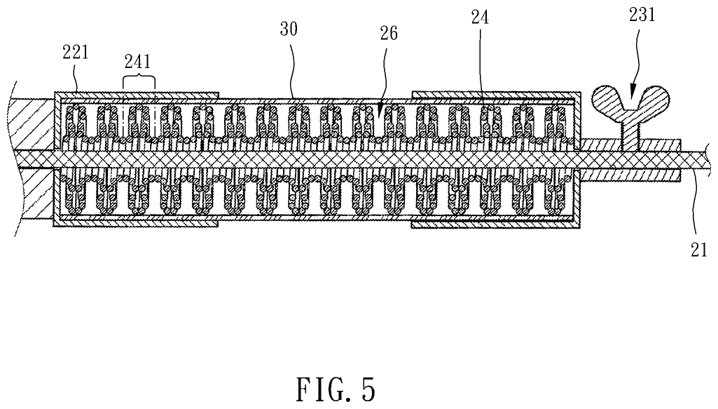

In this embodiment, the snare assembly 20 further includes a slide lock 25 slidably sleeved to the cable 21, an end of the cable 21 is restricted to the slide lock 25 to form the noose 211. The abutting mechanism 22 includes a first end cap 221 sleeved on the cable 21 and disposed between the slide lock 25 and the elastic member 24, and the restricting mechanism 23 includes a restricting member 231 and a second end cap 232 sleeved on the cable 21 and disposed between the elastic member 24 and the restricting member 231. The snare assembly 20 further includes a sleeving tube 30 sleeved on the cable 21 and located between the first and second end caps 221, 232, and the sleeving tube 30 is abuttable against the first end cap 221 and the second end cap 232 to define a receiving chamber 26. When the elastic member 24 is compressed and restricted by the restricting mechanism 23, the elastic member 24 is entirely received in the receiving chamber 26, which provides effective restriction to the elastic member 24 and is convenient to carry and set. Preferably, a length of the sleeving tube is smaller than or equal to 15 cm so as to effectively urge the elastic member 24 to compress. When the trigger base 10 is triggered, the elastic member 24 is released and stretches out of the sleeving tube 30 to effectively tighten the noose 21. In operation, the noose 211 is disposed around the trigger base 10 and the second end cap 232 is pushed toward the first end cap 221 to compress the elastic member 24, and the first end cap 221 and the sleeving tube 30 prevents the elastic member 24 from skewing or dislocation during compression, as show in FIG. 4. When the elastic member 24 is compressed to a predetermined length or the solid length L2, the second end cap 232 is blocked by the restricting member 231 so as to restrict stretching of the elastic member 24, as shown in FIG. 5. In other embodiments, the sleeving tube may be integrally connected with one of the first and second end caps; the restricting member may be integrally connected with the second end cap; the first and second end caps may be sleeved on the cable by components additionally disposed thereon.

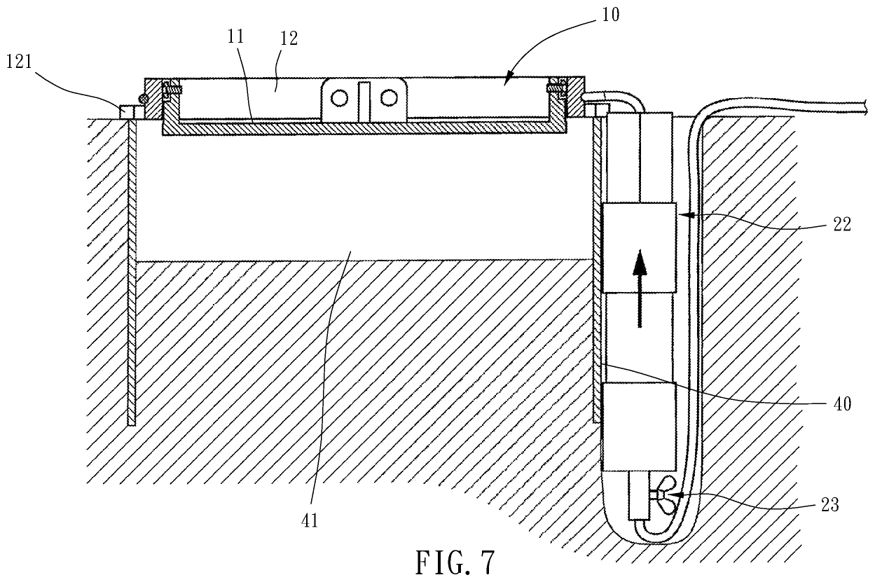

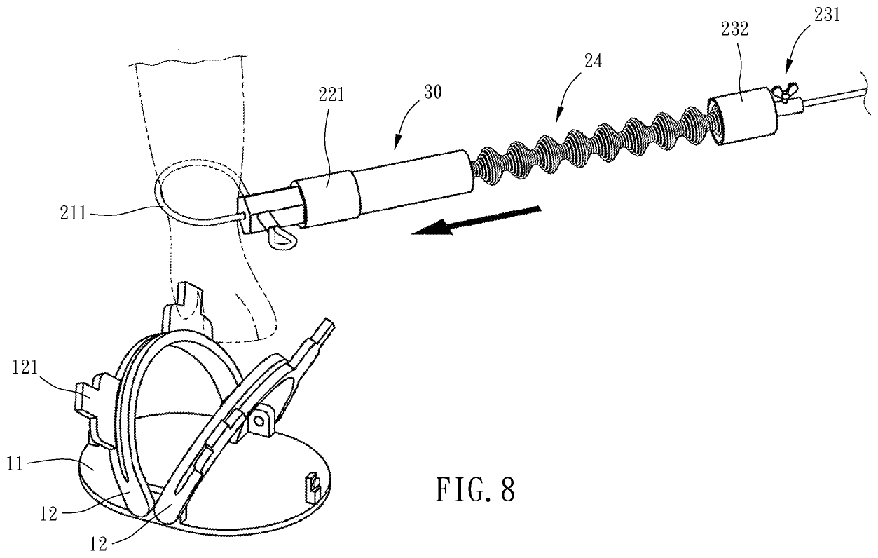

The snare trap further includes a blocking member 40 configured to be inserted within the ground. The blocking member 40 is a tube and includes a hollow portion 41 disposed thereon, and the trigger base 10 is disposed on the blocking member 40 and covers an opening of the hollow portion 41, as shown in FIG. 7. Moreover, since the elastic member 24 which is compressed is short enough, the snare assembly 20 has a small volume and can be vertically inserted in the ground, which largely decrease a space required to set the snare trap. The trigger base 10 includes a plate 11 and two clips 12 pivotally disposed on the plate 11, and a diametric dimension of the plate 11 is smaller than a diametric dimension of the opening. The two clips 12 respectively have at least one engaging arm 121 which radially extends outward and is releasebly disposed on the blocking member 40. When an animal is stepped on the plate 11, the two clips 12 are swung away from the plate 11, the noose 211 is detached form the clips 12 and sleeved on the animal's foot, and the elastic member 24 stretches and pushes the abutting member to tighten the noose 211 about the animal's foot, as shown in FIG. 8.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A snare trap, including:
a trigger base;
a snare assembly, including a cable having a noose, an abutting mechanism sleeved on the cable, a restricting mechanism disposed on the cable and an elastic member disposed between the abutting mechanism and the restricting mechanism, the noose being releasably disposed around the trigger base, the elastic member being compressible and restricted by the restricting mechanism;
wherein the elastic member includes a plurality of segments connected with one another, at least one of the plurality of segments includes a plurality of coils each having an outer diametric dimension different from an outer diametric dimension of another one of the plurality of coils, the elastic member has a free length when being free of compression;
when the noose is disposed around the trigger base and the elastic member is compressed and restricted by the restricting mechanism, at least two of the plurality of coils are radially overlapped with each other, and the elastic member has a solid length which is shorter than ⅓ of the free length.

2. The snare trap of claim 1, wherein the elastic member includes a plurality of large-diametric portions and a plurality of small-diametric portions which are axially alternatively arranged.

3. The snare trap of claim 2, wherein each of the plurality of segments spirally extends and is tapered from one of the plurality of large-diametric portions toward one of the plurality of small-diametric portions.

4. The snare trap of claim 2, wherein a ratio of a maximum outer diameter of one of the plurality of large-diametric portions to a minimum outer diameter of one of the plurality of small-diametric portions is between 2 and 5.

5. The snare trap of claim 1, wherein the elastic member includes at least 5 of said segments.

6. The snare trap of claim 1, wherein a diameter of the cable is between 2 mm and 10 mm.

7. The snare trap of claim 1, wherein a wire diameter of the elastic member is between 1.5 mm and 3.0 mm.

8. The snare trap of claim 1, wherein a ratio of a diameter of the cable to a wire diameter of the elastic member is between 2.0 and 3.5.

9. The snare trap of claim 1, further including a blocking member configured to be inserted within the ground, wherein the blocking member includes a hollow portion disposed thereon, and the trigger base is disposed on the blocking member and covers an opening of the hollow portion.

10. The snare trap of claim 1, wherein a ratio of the free length to the solid length is between 8 and 15.

11. The snare trap of claim 1, wherein the snare assembly further includes a slide lock slidably sleeved to the cable, an end of the cable is restricted to the slide lock to form the noose, the abutting mechanism includes a first end cap sleeved on the cable and disposed between the slide lock and the elastic member, and the restricting mechanism includes a restricting member and a second end cap sleeved on the cable and disposed between the elastic member and the restricting member.

12. The snare trap of claim 11, wherein the snare assembly further includes a sleeving tube sleeved on the cable and located between the first end cap and the second end cap, the sleeving tube is abuttable against the first end cap and the second end cap to define a receiving chamber; when the elastic member is compressed and restricted by the restricting mechanism, the elastic member is entirely received in the receiving chamber;
and when the trigger base is triggered, the elastic member is released and stretches out of the sleeving tube.

13. The snare trap of claim 12, wherein a length of the sleeving tube is smaller than or equal to 15 cm.

14. The snare trap of claim 4, wherein each of the plurality of segments spirally extends and is tapered from one of the plurality of large-diametric portions toward one of the plurality of small-diametric portions; the plurality of segments are continuously connected with one another; when the elastic member is compressed, part of the plurality of small-diametric portions are radially overlapped with the plurality of large-diametric portions; the elastic member includes at least 5 of said segments; a diameter of the cable is between 4 mm and 8 mm; a wire diameter of the elastic member is between 1.6 mm and 2.6 mm; a ratio of the diameter of the cable to the wire diameter of the elastic member is between 2.0 and 3.5; the snare trap further includes a blocking member configured to be inserted within the ground, the blocking member is a tube and includes a hollow portion disposed thereon, and the trigger base is disposed on the blocking member and covers an opening of the hollow portion; the trigger base includes a plate and two clips pivotally disposed on the plate, a diametric dimension of the plate is smaller than a diametric dimension of the opening; the two clips respectively have at least one engaging arm which radially extends outward and is releasebly disposed on the blocking member; a ratio of the free length to the solid length is between 8 and 15; the snare assembly further includes a slide lock slidably sleeved to the cable, an end of the cable is restricted to the slide lock to form the noose, the abutting mechanism includes a first end cap sleeved on the cable and disposed between the slide lock and the elastic member, and the restricting mechanism includes a restricting member and a second end cap sleeved on the cable and disposed between the elastic member and the restricting member; the snare assembly further includes a sleeving tube sleeved on the cable and located between the first end cap and the second end cap, the sleeving tube is abuttable against the first end cap and the second end cap to define a receiving chamber; when the elastic member is compressed and restricted by the restricting mechanism, the elastic member is entirely received in the receiving chamber; and when the trigger base is triggered, the elastic member is released and stretches out of the sleeving tube; and a length of the sleeving tube is smaller than or equal to 15 cm.
